(19) United States
(12) Patent Application Publication
(10) Pub. No.: US 2011/0089346 A1
(43) Pub. Date: Apr. 21, 2011

(54) METHOD AND SYSTEM FOR PATTERN WRITING WITH CHARGED-PARTICLE BEAM

(75) Inventor: Kaoru Tsuruta, Kanagawa (JP)

(73) Assignee: NuFlare Technology, Inc., Numazu-shi (JP)

(21) Appl. No.: 12/902,540

(22) Filed: Oct. 12, 2010

(30) Foreign Application Priority Data
Oct. 21, 2009 (JP) 2009-242806

(51) Int. Cl. G21K 5/10

(52) U.S. Cl. 250/492.22

(57) ABSTRACT

Irradiation position errors of a first charged-particle-beam writing apparatus are calculated by scanning a charged-particle beam across a calibration substrate on which two films having different reflectances are formed, with the calibration substrate being placed inside the first writing apparatus, and by then detecting signals indicative of charged particles reflected from the calibration substrate. Irradiation position errors of a second charged-particle-beam writing apparatus are calculated in a similar manner. Then, the differences between the calculated irradiation position errors of the first writing apparatus and the calculated irradiation position errors of the second writing apparatus are calculated to correct the irradiation position errors of the second writing apparatus based on the calculated differences.

### BACKGROUND OF THE INVENTION

1. Field of the Invention

The present invention relates to a method and a system for pattern writing with a charged-particle beam.

2. Background Art

Fabrication of semiconductor devices involves the use of photomasks or reticles (hereinafter referred to collectively as masks) on which circuit patterns are formed. The circuit patterns on a mask are photolithographically transferred onto a wafer with the use of a reduced-projection exposure system, often called a stepper, whereby the circuit patterns are formed on the wafer. Masks are manufactured using an electron-beam writing apparatus which is capable of writing fine patterns with an electron beam (see Japanese Patent Laid-Open No. 1997-293670). Attempts have also been made to develop laser-beam writing apparatuses which use a laser beam for pattern writing. The electron-beam writing apparatus is also used for directly writing circuit patterns on a wafer.

The recent larger-scale integration and capacity increases of LSI circuits have further reduced the circuit line widths needed for semiconductor devices. In fact, the dimensions of the smallest features of today's LSI circuits are as small as a single light wavelength used for pattern transfer. Further resolution increase is possible either by reducing the wavelength of light or by developing a new technique for acquiring an optical image smaller than the light wavelength. Another approach is by means of a light-phase shift method which utilizes light phase information.

The light-phase shift method typically involves the use of a phase-shift mask on which multiple light-transmitting regions are arranged. When illumination light passes through the light-transmitting regions on the mask, the light forms a mask pattern image on a wafer with the aid of an optical lens system. Assume here that the illumination light is coherent, meaning the waves of the light are in phase with each other. In that case, diffracted light from a transmitting region and diffracted light from its adjacent transmitting region are often in phase with each other and thus interfere with each other if the two regions are closely spaced, making image separation impossible. When, on the other hand, the phase of diffracted light from a transmitting region is shifted 180 degrees, diffracted light from its adjacent transmitting region will be cancelled out although they interfere with each other. Thus, images of the two transmitting regions can be separated. Accordingly, when light-transmitting regions exist on a mask in the form of, for example, a line-and-space pattern, a 180-degree phase shift of the light passing through ever other transmitting region improves image resolution drastically.

Representative phase-shift masks include alternating phase-shift masks, attenuated phase-shift masks, and rim phase-shift masks. These are all designed to prevent decreases in resolution and focal depth attributable to light interference, by a 180-degree phase shift of part of light passing through the masks. To impart phase differences to light, a mask can be provided with a thin, transparent film (i.e., a shifter) of thickness d and refractive index n. For example, a typical shifter for an attenuated phase-shift mask is formed of a Cr oxide film, an MoSi oxide film, or their combination. When the thickness d of that shifter is determined by the following formula, a 180-degree phase shift can be obtained.

d(nm)=λ(nm)/2(n−1)

A phase-shift mask is often fabricated by electron-beam writing apparatuses. A typical fabrication method involves the following steps. A resist film is first deposited on a substrate, and a first pattern is transferred on the resist film with the use of a first electron-beam writing apparatus. The substrate is then unloaded from the first writing apparatus, and an antistatic film is deposited on the resist film so that the resist film can be free of electrostatic charge. If electrons stay on the resist film during electron-beam irradiation, they form an electric field, which surrounds the space over the resist film, even permeating into the resist film. The electric field may bend the path of an electron beam, reducing the accuracy of the electron-beam writing. The antistatic film serves to prevent formation of such an electric field. After the deposition of the antistatic film, the substrate is loaded into a second electron-beam writing apparatus, and a second pattern is transferred onto the resist film by an electron beam.

When the second pattern is transferred, the first electron-beam writing apparatus which has been used for the transfer of the first pattern is not used; instead, the second electron-beam writing apparatus is used. This is due to the following reason.

An electron-beam writing apparatus is designed to emit an electron beam to a substrate placed on a stage, thereby writing a pattern on the substrate. The apparatus often includes a substrate transfer robot for transferring the substrate onto the stage. A problem with this transfer robot is that, even when the robot operates properly as required by control data, the position of the substrate may occasionally be shifted from a predetermined standard position on the stage. In that case, the entire pattern may be transferred in a shifted manner to the substrate. Therefore, alignment marks are often formed on the substrate, and an electron beam is scanned across the marks to detect their positions so that an electron beam can be directed accurately to desired positions during pattern writing.

During the detection of the alignment marks, a resist film on the substrate is exposed to an electron beam, and the electron beam causes resist materials to scatter from the resist film, resulting in contamination inside the apparatus. For this reason, when a second pattern is transferred, a second electron-beam writing apparatus is used which permits a higher level of contamination than a first electron-beam writing apparatus.

However, when first and second patterns are written with the use of two different electron-beam writing apparatuses, a possible displacement of a substrate due to their transfer robots is on the order of several millimeters. This displacement is far greater than when a single electron-beam writing apparatus is used to write the first and second patterns (in which case, a possible displacement of the substrate is on the order of 100 μm). Thus, when a second electron-beam writing apparatus performs alignment-mark detection, it needs to scan an electron beam across a relatively large area, which causes the amount of resist materials scattered to exceed the range the second writing apparatus can permit. Moreover, narrowing the electron-beam scan area necessitates the use of an expensive coordinate measurement instrument.

The present invention has been contrived to address the above issues. An object of the invention is to provide a system and a method for charged-particle-beam writing which are capable of reducing irradiation position shifts of a second charged-particle-beam writing apparatus when pattern writing is performed on a single substrate with the use of two charged-particle-beam writing apparatuses.

Other challenges and advantages of the present invention are apparent from the following description.

### SUMMARY OF THE INVENTION

According to one aspect of the present invention; A charged-particle-beam writing method for writing a first pattern on a substrate with the use of a first charged-particle-beam writing apparatus and then writing a second pattern on the substrate with the use of a second charged-particle-beam writing apparatus. According to another aspect of the invention, a method for calculating positioning errors by scanning a calibration substrate with a charged particle beam and measuring the signals reflected from the substrate. Then, correcting the irradiation position errors of the two apparatuses based on the calculated differences. The substrate is positioned by scanning a charged particle beam over the substrate's alignment marks.

The method also comprising a calibration substrate with a base substrate formed of a material that is lower in thermal expansion coefficient than a silicon oxide (SiO₂); a first electrically conductive film formed on the base substrate; and a second electrically conductive film that is formed on the first electrically conductive film and higher in reflectance than the first electrically conductive film. Wherein the first electrically conductive film includes one material selected from the group consisting of chromium (Cr), titanium (Ti), vanadium (V) and wherein the second electrically conductive film includes one material selected from the group consisting of tantalum (Ta), tungsten (W), platinum (Pt).

According to another aspect of the present invention; A charged-particle-beam writing system comprising a first charged-particle-beam writing apparatus; and a second charged-particle-beam writing apparatus wherein the second writing apparatus is configured such that irradiation position errors of the second writing apparatus are corrected based on the differences between irradiation position errors of the first writing apparatus and the irradiation position errors of the second writing apparatus.

### BRIEF DESCRIPTION OF THE DRAWINGS

FIG. 1 shows an electron-beam writing apparatus according to an embodiment of the invention.

FIG. 2 shows an electron-beam writing apparatus according to an embodiment of the invention.

FIG. 3 illustrates the structure of the calibration substrate.

FIG. 4 shows a cross-section of the calibration substrate of FIG. 3.

FIGS. 5A and 5B are diagrams illustrating a method for correcting writing positions with the use of a calibration substrate.

FIGS. 6A to 6C schematically illustrate shifts of write patterns from the substrate.

FIG. 7A shows a substrate and scan paths along which an irradiation spot SP moves.

FIG. 7B shows a cross-section of a part of alignment marks on a substrate.

FIG. 8 shows the relationship of a position of an irradiation spot and an amount of light received.

### DETAILED DESCRIPTION OF THE EMBODIMENTS

While the embodiments that follow are based on the assumption that phase-shift masks are to be fabricated, the invention is not limited to such a case. The invention is applicable wherever pattern writing is performed on a single substrate with the use of two different charged-particle-beam writing apparatuses.

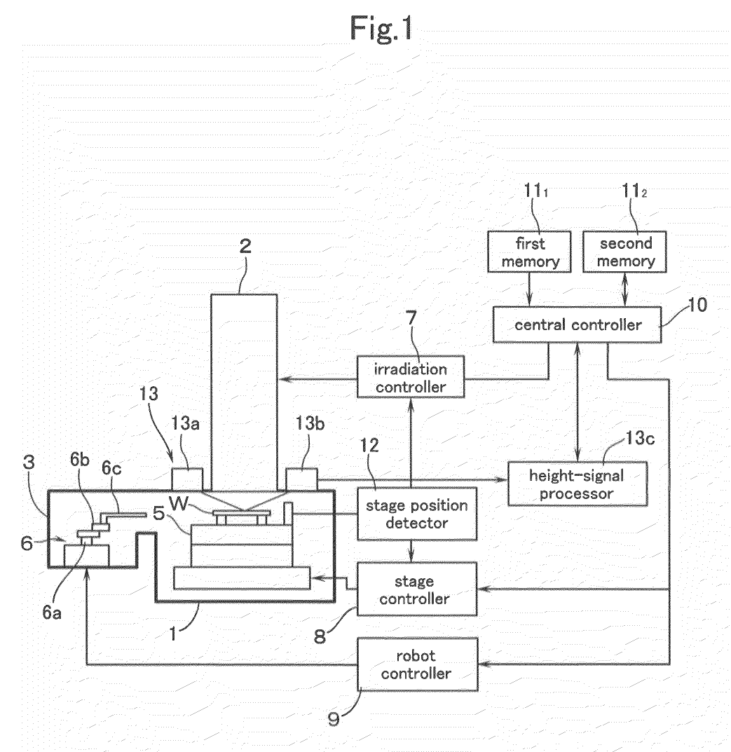

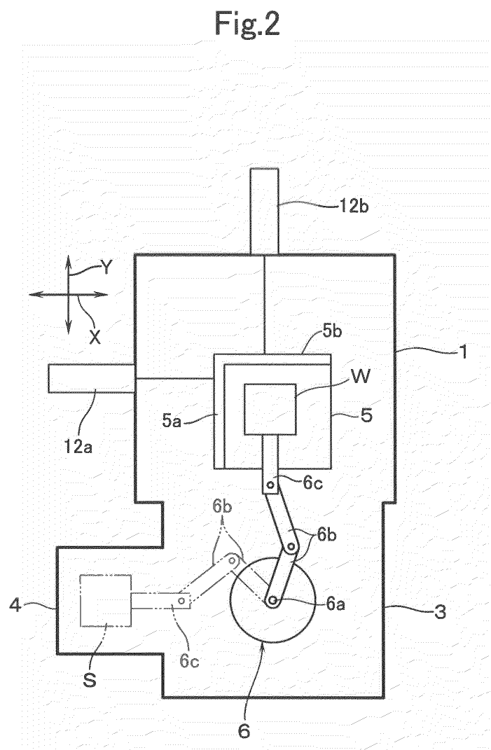

FIGS. 1 and 2 illustrate a first electron-beam writing apparatus according to an embodiment of the invention. A second electron-beam writing apparatus according to the embodiment is structurally the same. The first and second electron-beam writing apparatuses constitute a charged-particle-beam writing system according to the invention.

The first electron-beam writing apparatus includes a writing section 1, a substrate transfer section 3, and substrate placement section 4; and an electron beam column 2. The electron beam column 2, or beam irradiation means, is positioned vertically above the writing section 1. The substrate transfer section 3 is located adjacent to the writing section 1, and the substrate placement section 4 is at the side of the substrate transfer section 3. Located at the writing section 1 is a stage which is movable in mutually orthogonal X and Y directions. A substrate S is placed at a given position within the substrate placement section 4, and a transfer robot 6 is installed at the substrate transfer section 3. The transfer robot 6 is used to transfer the substrate S from the substrate placement section 4 onto the stage 5 at the writing section 1. The substrate S is, for example, a mask substrate formed by depositing a Cr oxide film and a resist film on a glass substrate.

The transfer robot 6 is a polar coordinate robot comprising the following components: a rotary shaft 6a that pivots on a Z-directional axis perpendicular to both X and Y directions; a robot arm 6b that is fixed to the rotary shaft 6a and capable of expanding/contracting in an X-Y plane; and a robot hand 6c attached to the distal end of the robot arm 6b and adapted to hold the substrate S. The expanding/contracting directions of the robot arm 6b are parallel to a Y direction when the transfer robot 6 places the substrate S on the stage 5. The robot hand 6c is always kept parallel to the expanding/contracting directions of the robot arm 6b. While the robot arm 6b of the present embodiment is designed to expand or contract by the stretching/bending motions of a pair of two arms, it may instead be a telescopic arm.

The electron beam column 2 houses an electron gun and is designed to shape an electron beam emitted therefrom to have a desired cross-section and then deflect the shaped electron beam on the substrate S. The electron beam column 2 may be well known and thus will not be discussed further. The electron beam column 2 is controlled by an irradiation controller 7. The stage 5 is controlled by a stage controller 8 while the transfer robot 6 is controlled by a robot controller 9. The entire operation of these controllers 7, 8, and 9 is controlled by a central controller 10. Connected to the central controller 10 are a first memory 11₁ and a second memory 11₂. The first memory 11₁ is designed to store pattern data. Based on the pattern data, the central controller 10 creates write data specifying the shapes and locations of geometric plane figures to be written and then stores the write data on the second memory 11₂.

The first electron-beam writing apparatus further includes a stage position detector 12 and a height detector 13. The stage position detector 12 detects the X- and Y-directional positions of the stage 5 while the height detector 13 detects the height (i.e., Z-directional position) of the substrate S placed on the stage 5. As illustrated in FIG. 2, the stage position detector 12 includes two laser measurement devices, 12a and 12b. The laser measurement device 12a detects the X-directional position of the stage 5 by sensing laser light incident on and reflected by a stage mirror 5a which is fixed to the stage 5 such that the mirror 5a is parallel to a Y direction. The laser measurement device 12b detects the Y-directional position of the stage 5 by sensing laser light incident on and reflected by a stage mirror 5b which is fixed to the stage 5 such that the mirror 5b is parallel to an X direction.

The height detector 13 includes the following components: a light emitter 13a that focuses laser light onto the substrate S obliquely from above; a light receiver 13b that receives reflected light from the substrate S and thereby detects the position of the reflected light; and a height-signal processor 13c that calculates the height of the substrate S from the detected position of the reflected light. The height data of the substrate S obtained by the height detector 13 is input to the central controller 10 as response data when so instructed by the central controller 10. The central controller 10 then calculates the deflection angles and focal depth range of an electron beam necessary to maintain pattern writing accuracy, based on how far the height of the substrate S is shifted from a predetermined standard height, thereby correcting the write data. It should be noted that the height-signal processor 13c also has the function of detecting the amount of the reflected light received, by performing calculations on a height signal received from the light receiver 13b.

Due to the inability of the stage position detector 12 to detect the position of the substrate S, an entire pattern will be written in a shifted manner on the substrate S if the substrate S is not properly placed at a predetermined standard position on the stage 5. The shift of the substrate S from the standard position may sometimes happen even when the transfer robot 6 operates properly as required by control data. Accordingly, global positional errors of the substrate S are corrected with the use of a calibration substrate on which patterns are arranged at regular intervals.

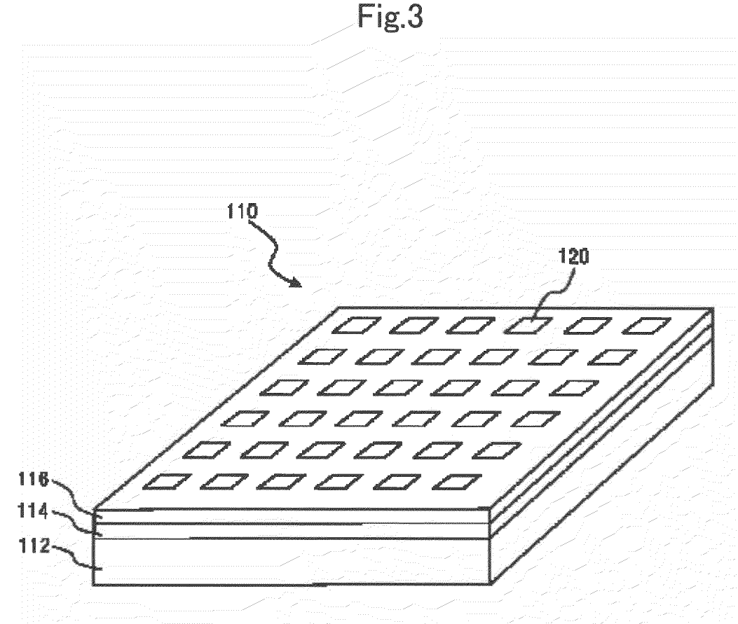

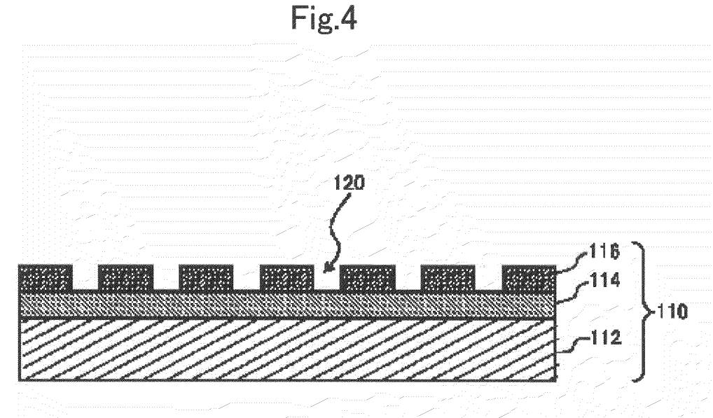

FIG. 3 illustrates the structure of the calibration substrate, with FIG. 4 being its cross-section. The calibration substrate, denoted by reference numeral 110, comprises a base substrate 112 and electrically conductive films 114 and 116. The conductive film 114 (first conductive film) is deposited on the base substrate 112, and the conductive film 116 (second conductive film) is deposited on the conductive film 114. Multiple recesses 120 are present in the conductive film 116; the recesses 120 are arranged at regular intervals and extend down through the conductive film 116 up to the top surface of the conductive film 114. It is preferred that the recesses 120 be arranged at substantially regular intervals across the conductive film 116 so that some of the recesses 120 will not be located densely at certain locations. By detecting the position of each of the recesses 120, the position of the stage 5 can be corrected. Connected from above to the conductive film 114 or 116 is a grounding material (e.g., grounding pin). By connecting the grounding material to the calibration substrate 110 and also covering the top surface of the calibration substrate 110 with the conductive films 114 and 116, electrostatic charge can be avoided during electron-beam irradiation. Thus, the positional measurement is free of unexpected errors due to electrostatic charge.

The conductive film 116 is preferably higher in electron-beam reflectance than the conductive film 114. The conductive film 116 may be formed, for example, of atoms whose atomic number is equal to or greater than 73. The use of such atoms makes the electron-beam reflectance of the conductive film 116 higher than that of the conductive film 114 when the conductive film 114 is made of atoms whose atomic number is smaller than 73. It is also preferred that the conductive film 116 be formed of a material whose melting point is as high as the melting point of the base substrate 112. The use of such a material prevents the conductive film 116 from melting during electron beam exposure. The melting point of such a material is preferably 1,000 degrees Celsius or higher. It is further preferred that the conductive film 116 be formed of a hard, non-corrodible material. Because the calibration substrate 110 is used over and over and its top surface is exposed to a chemical solution for cleaning purposes, the use of a hard, non-corrodible material protects the conductive film 116 from film corrosion or deformation. Examples of materials that meet the above requirements include tantalum (Ta), tungsten (W), platinum (Pt), and their compounds.

The conductive film 114 is preferably lower in electron-beam reflectance than the conductive film 116. The conductive film 114 may be formed, for example, of atoms whose atomic number is smaller than 73. The use of such atoms makes the electron-beam reflectance of the conductive film 114 lower than that of the conductive film 116 when the conductive film 116 is made of atoms whose atomic number is equal to or greater than 73. It is also preferred that the conductive film 114 be formed of a material whose melting point is as high as the melting point of the base substrate 112. The use of such a material prevents the conductive film 114 from melting during electron beam exposure. The melting point of such a material is preferably 1,000 degrees Celsius or higher. It is further preferred that the conductive film 114 be formed of a hard, non-corrodible material. Because the calibration substrate 110 is used over and over and its top surface is exposed to a chemical solution for cleaning purposes, the use of a hard, non-corrodible material protects the conductive film 114 from film corrosion or deformation. Examples of materials that meet the above requirements include chromium (Cr), titanium (Ti), vanadium (V), and their compounds.

It is to be noted, however, that the conductive films 114 and 116 are only required to be different in electron-beam reflectance and not limited to the above-mentioned metal materials.

By the bottom and side surfaces of the recesses 120 being defined and formed by the conductive films 114 and 116, respectively, which are different in electron-beam reflectance, the contrast of signals obtained during electron-beam scanning can be increased. Accordingly, the positions of the recesses 120 can be detected with considerable accuracy.

The base substrate 112 is preferably formed of a material whose thermal expansion coefficient is lower than that of SiO₂. If the base substrate 112 is a glass substrate formed of SiO₂ (in which case, the thermal expansion coefficient of the base substrate 112 is approximately 1 ppm/° C.), the base substrate 112 may thermally expand during electron-beam scanning, resulting in positional errors. In contrast, when the base substrate 112 is formed of a material whose thermal expansion coefficient is lower than that of SiO₂ (e.g., Ti-doped SiO₂ material), the thermal expansion coefficient of the base substrate 112 can be reduced to as low as 0±30 ppb/° C. In that case, it is possible to prevent thermal expansion of the base substrate 112 and associated positional errors during electron-beam scanning.

During actual electron-beam writing, the substrate S is placed on the stage 5, supported by three pins. When the stage 5 is moved, however, the substrate S may slide on the pins, resulting in displacement of the substrate S. To monitor such displacement, it is preferred that the bottom surface of the calibration substrate 110 be in as similar a state as possible to the bottom surface of the substrate S. The bottom surface of the substrate S is typically not processed at all; thus, it is preferred that the bottom surface of the calibration substrate 110 be also not processed so that the low thermal expansion base substrate 112 can be exposed.

Correction of electron-beam writing positions (i.e., electron-beam irradiation positions) with the use of the calibration substrate 110 is performed by measuring the positions of the recesses 120 on the calibration substrate S. This measurement will now be described in detail.

With the calibration substrate 10 being placed on the stage 5, the first electron-beam writing apparatus radiates an electron beam from the electron gun housed by the electron beam column 2 onto the calibration substrate 110. In this case, beam shaping is not necessary. The irradiation controller 7 performs deflection control on the electron beam, thereby scanning the electron beam across the calibration substrate 110. The electrons reflected from the top surface of the calibration substrate 110 are then detected in the form of signals by a detector not illustrated. The detector amplifies the signals and outputs the amplified signals to the central controller 10. When the irradiation controller 7 scans the electron beam across some of the recesses 120 which are out of the deflection range, the stage 5 can be moved for the purpose of adjusting scanning positions.

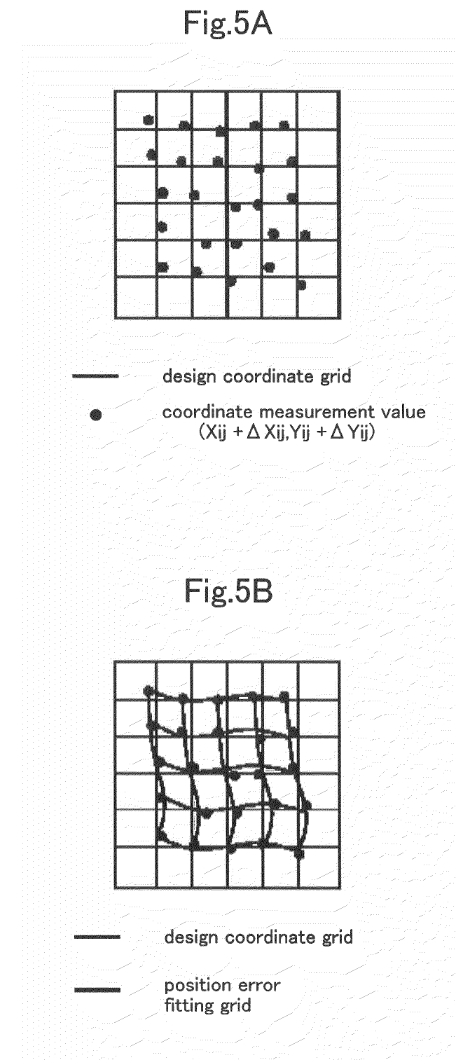

FIGS. 5A and 5B are diagrams to illustrate a method for correcting writing positions with the use of the calibration substrate 110. As illustrated in FIG. 5A, the measured positions of the recesses 120 are placed on a substrate coordinate grid. Because electrons reflected from the conductive films 114 and 116 having different reflectances result in large-contrast detection signals, the positions of the recesses 120 can be detected with high accuracy. Moreover, since the top surface of the calibration substrate 110 is covered with the conductive films 114 and 116, it is possible to avoid measurement errors due to electrostatic charge. In addition, the use of a material with a low thermal expansion coefficient for the base substrate 112 prevents measurement errors attributable to thermal expansion of the base substrate 112.

The measured positions of the recesses 120 are then approximated (curve fitting) with the use of polynomials, resulting in the positional error map of FIG. 5B. The X-directional positional error ΔXᵢⱼ and Y-directional positional error ΔYᵢⱼ of each of the measured positions of the recesses 120 from its corresponding intersection grid point can be approximated by, for example, the following two-variable cubic polynomials (1) and (2).

ΔXᵢⱼ=A₀+A₁·Xᵢⱼ+A₂·Yᵢⱼ+A₃·Xᵢⱼ²+A₄·Xᵢⱼ·Yᵢⱼ+A₅·Yᵢⱼ²+A₆·Xᵢⱼ³+A₇·Xᵢⱼ²·Yᵢⱼ+A₈·Xᵢⱼ·Yᵢⱼ²+A₉·Yᵢⱼ³ Formula (1)

ΔYᵢⱼ=B₀+B₁·Xᵢⱼ+B₂·Yᵢⱼ+B₃·Xᵢⱼ²+B₄·Xᵢⱼ·Yᵢⱼ+B₅·Yᵢⱼ²+B₆·Xᵢⱼ³+B₇·Xᵢⱼ²·Yᵢⱼ+B₈·Xᵢⱼ·Yᵢⱼ²+B₉·Yᵢⱼ³ Formula (2)

The central controller 10 calculates the coefficients A₀ to A₉ and B₀ to B₉ and then applies them to the irradiation controller 7. At the time of electron-beam writing on the substrate S, the irradiation controller 7 performs deflection control on an electron beam so that the beam can be directed to positions obtained by correcting the coordinates of writing positions based on the X-direction positional errors ΔXᵢⱼ and Y-directional positional errors ΔYᵢⱼ calculated from the above formulae (1) and (2). Coordinate errors that may be involved in forming the recesses 120 regularly in the conductive film 116 are measured in advance so that they will not affect the coefficients A₀ to A₉ and B₀ to B₉.

Described next is a method for writing a first pattern on the substrate S with the use of the first electron-beam writing apparatus.

After the first electron-beam writing apparatus is activated, an electron beam is first scanned across the calibration substrate 110 to detect electrons reflected from the calibration substrate 110.

Based on the obtained result, errors in irradiation positions from the electron beam are corrected. To correct the errors, a positional error map can be created as above. The X-directional positional error ΔXᵢⱼ and Y-directional positional error ΔYᵢⱼ of each of the measured positions of the recesses 120 from its corresponding intersection grid point can be approximated by the above formulae (1) and (2). The central controller 10 calculates the coefficients A₀ to A₉ and B₀ to B₉ and then inputs them to the irradiation controller 7. At the time of electron-beam writing on the substrate S, the irradiation controller 7 performs deflection control on an electron beam so that the beam can be directed to positions obtained by correcting the coordinates of writing positions based on the X-direction positional errors ΔXᵢⱼ and Y-directional positional errors ΔYᵢⱼ calculated from the above formulae (1) and (2). This allows the first pattern to be written on the desired position on the substrate S.

After the first pattern is written, the substrate S is unloaded out of the first electron-beam writing apparatus. Then, an antistatic film is deposited on the top surface of the substrate S. The substrate S is thereafter loaded into the second electron-beam writing apparatus. As already stated, the second electron-beam writing apparatus is structurally the same as the first electron-beam writing apparatus illustrated in FIG. 1.

To write a second pattern with the use of the second electron-beam writing apparatus, correction of errors in electron-beam irradiation positions is also required for the second electron-beam writing apparatus. At this time, however, correcting those errors of the second writing apparatus using the X-directional positional errors ΔXᵢⱼ and Y-directional positional errors ΔYᵢⱼ, which have been used for the first writing apparatus, does not ensure that an electron beam will be directed to desired positions on the substrate S placed inside the second writing apparatus. For example, if the first and second patterns are written with the use of a single electron-beam writing apparatus, a possible displacement of the substrate S is on the order of 100 μm. In contrast, when the first and second patterns are written with the use of two different electron-beam writing apparatuses, a possible displacement of the substrate S can be on the order of several millimeters. This suggests the presence of positional differences between the two apparatuses.

In the present embodiment, therefore, the calibration substrate 110 which has been used for the first electron-beam writing apparatus is also used for the second electron-beam writing apparatus to create a positional error map. Then, the differences between positional errors of the first writing apparatus and positional errors of the second writing apparatus are calculated to obtain the positional differences between the first and second writing apparatuses. When these positional differences are input to the irradiation controller 7 of the second writing apparatus, they can be adjusted accordingly.

Creating a positional error map with the second writing apparatus takes the same procedures as above. The calibration substrate 110 is loaded into the second writing apparatus, and an electron beam is scanned across the calibration substrate 110 to measure the positions of the recesses 120 on the calibration substrate 110. The measured positions are then approximated (curve fitting) with the use of polynomials, thereby obtaining a positional error map.

As regards the second electron-beam writing apparatus, the X-directional positional error ΔX_{ij′} and Y-directional positional error ΔY_{ij′} of each of the measured positions of the recesses 120 from its corresponding intersection grid point can be approximated by, for example, the following two-variable cubic polynomials (3) and (4).

ΔX_{ij′}=A_{0′}+A_{1′}·Xᵢⱼ+A_{2′}·Yᵢⱼ+A_{3′}·Xᵢⱼ²+A_{4′}·Xᵢⱼ·Yᵢⱼ+A_{5′}·Yᵢⱼ²+A_{6′}·Xᵢⱼ³+A_{7′}·Xᵢⱼ²·Yᵢⱼ+A_{8′}·Xᵢⱼ·Yᵢⱼ²+A_{9′}·Yᵢⱼ³ Formula (3)

ΔY_{ij′}=B_{0′}+B_{1′}·Xᵢⱼ+B_{2′}·Yᵢⱼ+B_{3′}·Xᵢⱼ²+B_{4′}·Xᵢⱼ·Yᵢⱼ+B_{5′}·Yᵢⱼ²+B_{6′}·Xᵢⱼ³+B_{7′}·Xᵢⱼ²·Yᵢⱼ+B_{8′}·Xᵢⱼ·Yᵢⱼ²+B_{9′}·Yᵢⱼ³ Formula (4)

The central controller 10 of the second writing apparatus calculates the respective differences between the coefficients A₀ to A₉ and B₀ to B₉ obtained from the first writing apparatus and the coefficients A_{0′} to A_{9′} and B_{0′} to B_{9′} obtained from the second writing apparatus. The central controller 10 then transmits the calculated differences (A_{0′}−A₀) to (A_{9′}−A₉) and (B_{0′}−B₀) to (B_{9′}−B₉) to the irradiation controller 7 of the second writing apparatus. Before electron-beam writing on the substrate S, the irradiation controller 7 applies the coefficients of the formulae (3) and (4) corrected coefficients that are obtained by performing addition on differences dA₀ to dA₉ and dB₀ and dB₉ for each coordinate set of writing positions. The difference dA₀ is (A₀−A_{0′}), for example. The irradiation controller 7 thus performs deflection control on an electron beam so that the beam can be directed to positions obtained by correcting the coordinates of the writing positions based on the X-direction positional errors ΔX_{ij′} and Y-directional positional errors ΔY_{ij′} calculated from the above formulae (3) and (4) into which the corrected coefficients were applied. This allows the second writing apparatus to align the substrate S with ease. When the substrate S has alignment marks thereon, it is possible to reduce the entire electron-beam scan area by scanning an electron beam only across the alignment marks. In that case, scattering of resist materials from the resist film on the substrate S can also be minimized.

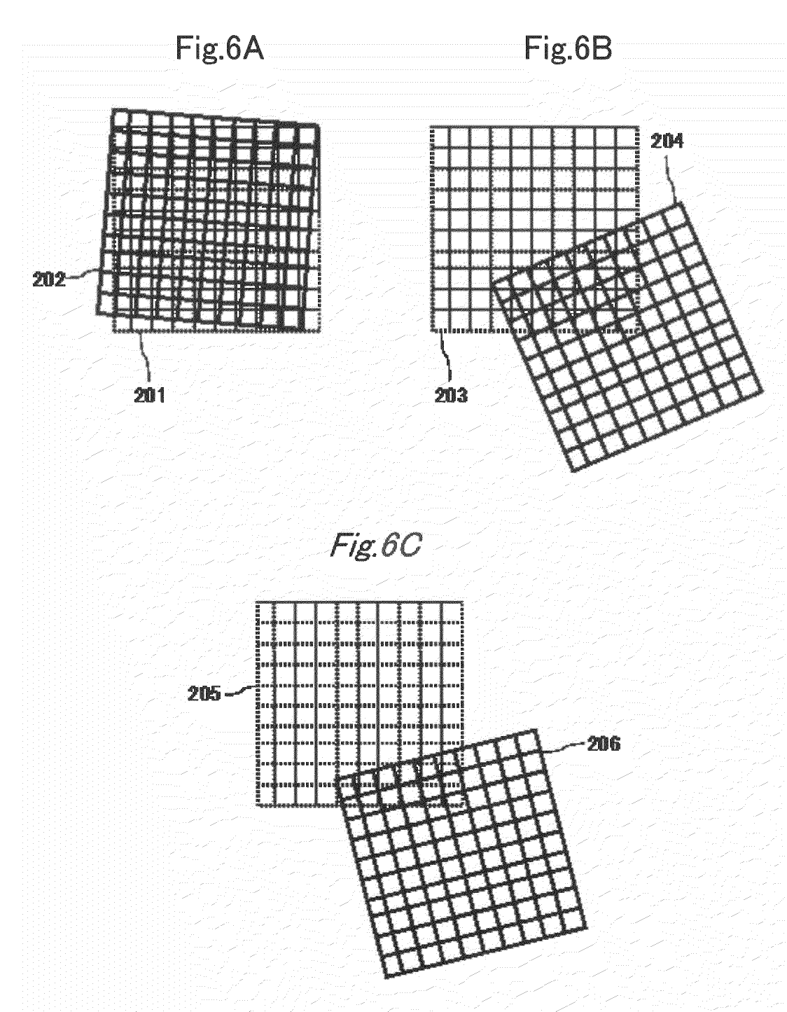

FIGS. 6A to 6C schematically illustrate shifts of write patterns from the substrate S when the substrate S is not properly placed at a predetermined standard position on the stage 5. FIG. 6A illustrates global positional errors of the calibration substrate 110 when the calibration substrate 110 is placed inside the first writing apparatus. Reference numeral 201 denotes the standard position where the substrate S should be located, and reference numeral 202 denotes a shift of the calibration substrate from the standard position. FIG. 6B illustrates global positional errors of the calibration substrate 110 when the calibration substrate 110 is placed inside the second writing apparatus. Reference numeral 203 denotes the standard position where the substrate S should be located, and reference numeral 204 denotes a shift of the calibration substrate 110 from the standard position. In FIG. 6C, reference numeral 205 denotes the standard position where the substrate S should be located, and reference numeral 206 denotes the differences between the positional errors obtained from the first writing apparatus and the positional errors obtained from the second writing apparatus.

Described next with reference to FIGS. 1, 7, and 8 is a method, according to another embodiment, for correcting electron-beam irradiation positions with the use of a substrate S having alignment marks thereon.

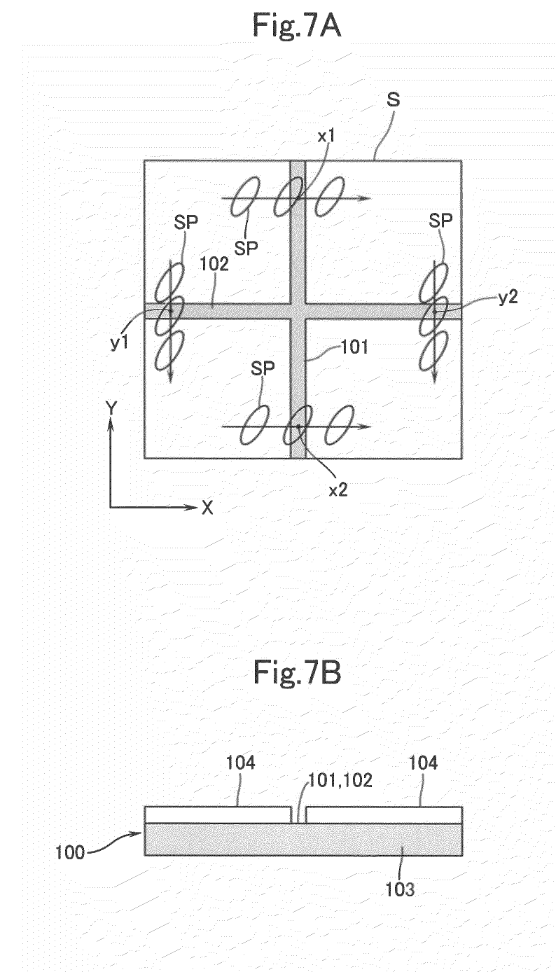

As illustrated in FIG. 7A, two linear alignment marks 101 and 102 are formed on a substrate S. The alignment marks 101 and 102 cross each other perpendicularly and differ in light reflectance from the other portions on the substrate S. This substrate S is placed at the standard position on the stage 5 such that the alignment marks 101 and 102 are parallel to a Y direction and an X direction, respectively. In this embodiment, the substrate S is formed by first depositing a light-shielding film 104 (e.g., a chromium film) on the top surface of a glass substrate 103, as illustrated in FIG. 7B. The alignment marks 101 and 102 are then formed by removing part of the light-shielding film 104. The alignment marks 101 and 102 are lower in light reflectance than the light-shielding film 104.

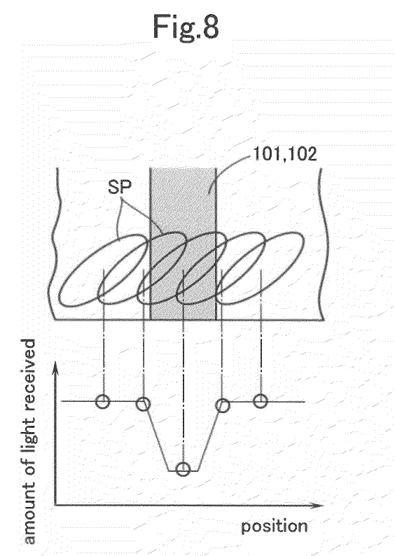

In this embodiment, an electron beam is scanned across the alignment marks 101 and 102 to detect scan paths along which an irradiation spot SP moves and the intersections of the scan paths with the alignment marks 101 and 102. In the case of alignment mark detection with the use of a laser beam, the diameter of its beam spot is relatively large; thus, the amount of light received varies in the form of the Gaussian distribution (normal distribution). In contrast, the diameter of an electron beam spot is smaller than that of a laser beam. Therefore, the use of an electron beam for detection of the alignment marks 101 and 102 results in such detection signals as illustrated in FIG. 8. As is obvious from the signal waveform of FIG. 8, the use of an electron beam allows accurate detection of the scan paths and the intersections of the scan paths with the alignment marks 101 and 102. According to this embodiment, it is also possible to reduce the entire electron-beam scan area by scanning an electron beam only across the alignment marks 101 and 102. Thus, scattering of resist materials from the resist film on the substrate S can be minimized.

After correction of electron-beam irradiation positions with the use of the above substrate S, a first pattern is written on the substrate S with the use of the first writing apparatus. Then, a second pattern is written on the substrate S with the use of the second writing apparatus. Also, in this embodiment, the central controller 10 of the second writing apparatus calculates the respective differences between the coefficients A₀ to A₉ and B₀ to B₉ obtained from the first writing apparatus and the coefficients A_{0′} to A_{9′} and B_{0′} to B_{9′} obtained from the second writing apparatus. The central controller 10 then transmits the calculated differences (A_{0′}−A₀) to (A_{9′}−A₉) and (B_{0′}−B₀) to (B_{9′}−B₉) to the irradiation controller 7 of the second writing apparatus. Before writing the second pattern on the substrate S, the irradiation controller 7 applies the coefficients of the formulae (3) and (4) corrected coefficients that are obtained by performing addition on the differences dA₀ to dA₉ and dB₀ and dB₉ for each coordinate set of writing positions. The difference dA₀ is (A₀−A_{0′}), for example. The irradiation controller 7 thus performs deflection control on an electron beam so that the beam can be directed to positions obtained by correcting the coordinates of the writing positions based on the X-direction positional errors ΔX_{ij′} and Y-directional positional errors ΔY_{ij′} calculated from the above formulae (3) and (4) into which the corrected coefficients were applied. According to this embodiment, the entire electron-beam scan area can be reduced by scanning an electron beam only across the alignment marks 101 and 102. Thus, it is possible to minimize scattering of resist materials from the resist film on the substrate S.

As above, according to a charged-particle-beam writing method of the invention, irradiation position errors of a first charged-particle-beam writing apparatus are calculated by scanning a charged-particle beam across a calibration substrate on which two films having different reflectances are formed, with the calibration substrate being placed inside the first writing apparatus, and by then detecting signals indicative of charged particles reflected from the calibration substrate. Further, irradiation position errors of a second charged-particle-beam writing apparatus are calculated by scanning a charged-particle beam across the same calibration substrate with the calibration substrate being placed inside the second writing apparatus and by then detecting signals indicative of charged particles reflected from the calibration substrate. Then, the differences between the calculated irradiation position errors of the first writing apparatus and the calculated irradiation position errors of the second writing apparatus are calculated to correct the irradiation position errors of the second writing apparatus based on the calculated differences. Thus, it is possible to reduce shifts of irradiation positions of the second writing apparatus.

According to another method of the invention in which irradiation position errors are corrected by scanning a charged-particle beam across alignment marks on a substrate, therefore the errors can be corrected with a high degree of accuracy. In this case, the entire electron-beam scan area can be reduced by scanning an electron beam only across the alignment marks. Thus, it is possible to minimize scattering of resist materials from a resist film on the substrate. Moreover, desired patterns can be transferred on the substrate only by correcting irradiation positions of the charged-particle beam, without correcting the position of the substrate.

A charged-particle-beam writing system according to the invention comprises a first charged-particle-beam writing apparatus and a second charged-particle-beam writing apparatus. The second writing apparatus is configured such that irradiation position errors of the second writing apparatus are corrected based on the differences between irradiation position errors of the first writing apparatus and the irradiation position errors of the second writing apparatus. The irradiation position errors of the first writing apparatus are calculated by scanning a charged-particle beam across a calibration substrate on which two films having different reflectances are formed, with the calibration substrate being placed inside the first writing apparatus, and by then detecting signals indicative of charged particles reflected from the calibration substrate. The irradiation position errors of the second writing apparatus are calculated by scanning a charged-particle beam across the calibration substrate with the calibration substrate being placed inside the second writing apparatus and by then detecting signals indicative of charged particles reflected from the calibration substrate. According to the above system, it is possible to reduce shifts of irradiation positions of the second writing apparatus.

The features and advantages of the present invention may be summarized as follows:

When pattern writing is performed on a single substrate with the use of two charged-particle-beam writing apparatuses, a first aspect of the invention provides a charged-particle-beam writing method which is capable of reducing irradiation position shifts of the second writing apparatus.

When pattern writing is performed on a single substrate with the use of two charged-particle-beam writing apparatuses, a second aspect of the invention provides a charged-particle-beam writing system which is capable of reducing irradiation position shifts of the second writing apparatus.

While embodiments of the invention have been described with reference to the accompanying drawings, the invention is not limited thereto. As stated above, the above embodiments are based on the following pattern writing steps: 1) forming a resist film on a substrate; 2) transferring a first pattern on the resist film with the use of a first electron-beam writing apparatus; 3) unloading the substrate from the first writing apparatus; 4) depositing an antistatic film on the resist film; 5) loading the substrate into a second electron-beam writing apparatus; and 6) transferring a second pattern on the resist film with the use of the second writing apparatus. However, the invention is not limited to these steps, nor to fabrication of phase-shift masks. As long as pattern writing is performed on a single substrate with the use of multiple charged-particle-beam writing apparatuses, application of the invention leads to advantages similar to those described above.

Further, while the above embodiments are applications of the invention to substrate position measurement for electron-beam writing apparatuses, the invention can also be applied to other charged-particle-beam writing apparatuses that use ion beams, for example.

While the description of the above-described embodiments has centered on what is directly relevant to the device configurations and control methods of the present invention, it is of course possible to make modifications thereto. For instance, modifications can be made to the foregoing control unit configuration for controlling an electron-beam writing apparatus.

Obviously many modifications and variations of apparatus and/or methods are possible in light of the present invention. It is therefore to be understood that within the scope of the appended claims the invention may be practiced otherwise than as specifically described.

The entire disclosure of a Japanese Patent Application No. 2009-242806, filed on Oct. 21, 2009 including specification, claims, drawings and summary, on which the Convention priority of the present application is based, are incorporated herein.

What is claimed is:

1. A charged-particle-beam writing method for writing a first pattern on a substrate with the use of a first charged-particle-beam writing apparatus and then writing a second pattern on the substrate with the use of a second charged-particle-beam writing apparatus, the method comprising:
calculating irradiation position errors of the first writing apparatus by scanning a charged-particle beam across a calibration substrate on which two films having different reflectances are formed, with the calibration substrate being placed inside the first writing apparatus, and by then detecting signals indicative of charged particles reflected from the calibration substrate;
calculating irradiation position errors of the second writing apparatus by scanning a charged-particle beam across the calibration substrate with the calibration substrate being placed inside the second writing apparatus and by then detecting signals indicative of charged particles reflected from the calibration substrate;
calculating the differences between the calculated irradiation position errors of the first writing apparatus and the calculated irradiation position errors of the second writing apparatus; and
correcting the irradiation position errors of the second writing apparatus based on the calculated differences.

2. The method of claim 1 wherein the calibration substrate comprises:
a base substrate formed of a material that is lower in thermal expansion coefficient than a silicon oxide (SiO₂);
a first electrically conductive film formed on the base substrate; and
a second electrically conductive film that is formed on the first electrically conductive film and higher in reflectance than the first electrically conductive film.

3. The method of claim 2 wherein the first electrically conductive film includes one material selected from the group consisting of chromium (Cr), titanium (Ti), vanadium (V) and wherein the second electrically conductive film includes one material selected from the group consisting of tantalum (Ta), tungsten (W), platinum (Pt).

4. The method of claim 1 wherein the substrate has alignment marks thereon and wherein the method comprises:
loading the substrate into the first writing apparatus and aligning the substrate by scanning a charged-particle beam across the alignment marks; and
loading the substrate into the second writing apparatus and aligning the substrate by scanning a charged-particle beam across the alignment marks.

5. The method of claim 4 wherein the calibration substrate comprises:
a base substrate formed of a material that is lower in thermal expansion coefficient than a silicon oxide (SiO₂);
a first electrically conductive film formed on the base substrate; and
a second electrically conductive film that is formed on the first electrically conductive film and higher in reflectance than the first electrically conductive film.

6. The method of claim 5 wherein the first electrically conductive film includes one material selected from the group consisting of chromium (Cr), titanium (Ti), vanadium (V) and wherein the second electrically conductive film includes one material selected from the group consisting of tantalum (Ta), tungsten (W), platinum (Pt).

7. A charged-particle-beam writing system comprising:
a first charged-particle-beam writing apparatus; and
a second charged-particle-beam writing apparatus,
wherein the second writing apparatus is configured such that irradiation position errors of the second writing apparatus are corrected based on the differences between irradiation position errors of the first writing apparatus and the irradiation position errors of the second writing apparatus,
wherein the irradiation position errors of the first writing apparatus are calculated by scanning a charged-particle beam across a calibration substrate on which two films having different reflectances are formed, with the calibration substrate being placed inside the first writing apparatus, and by then detecting signals indicative of charged particles reflected from the calibration substrate, and
wherein the irradiation position errors of the second writing apparatus are calculated by scanning a charged-particle beam across the calibration substrate with the calibration substrate being placed inside the second writing apparatus and by then detecting signals indicative of charged particles reflected from the calibration substrate.

8. The system of claim 7 wherein the calibration substrate comprises:
a base substrate formed of a material that is lower in thermal expansion coefficient than a silicon oxide (SiO₂);
a first electrically conductive film formed on the base substrate; and
a second electrically conductive film that is formed on the first electrically conductive film and higher in reflectance than the first electrically conductive film.

9. The system of claim 8 wherein the first electrically conductive film includes one material selected from the group consisting of chromium (Cr), titanium (Ti), vanadium (V) and wherein the second electrically conductive film includes one material selected from the group consisting of tantalum (Ta), tungsten (W), platinum (Pt).
